(19) United States
(12) Patent Application Publication
(10) Pub. No.: US 2014/0270723 A1
(43) Pub. Date: Sep. 18, 2014

(54) ELECTRO-ACOUSTIC RESONANCE HEATER

(71) Applicant: VERTECH IP, LLC, Newark, DE (US)

(72) Inventor: Gerard Henri Froussart, Sergeac (FR)

(73) Assignee: VERTECH IP, LLC, Newark, DE (US)

(21) Appl. No.: 13/843,012

(22) Filed: Mar. 15, 2013

(51) Int. Cl. H05B 3/04

(52) U.S. Cl. CPC H05B 3/04
USPC 392/322

(57) ABSTRACT

An apparatus for heating a liquid includes an electro-acoustic resonator disposed inside a container. The electro-acoustic resonator includes a concave rigid emitter and a substantially hollow receiver spaced closely apart from and mounted in the emitter. The emitter may be configured in the form of a hemisphere, and the receiver in the form of generally spherical bladder containing a free-moving sold mass in a gas. The container may be in the form of a cylinder. During operation, an AC power source is applied to the emitter and the receiver is wired to ground. The resonator generates acoustical energy, heating a liquid (e.g., water) as it flows through the container.

### BACKGROUND

1. Field

The present disclosure relates to methods and apparatus for heating water or similar incompressible fluids, and more particularly to methods and apparatus for electrical-acoustic resonance heating of liquids.

2. Description of Related Art

Various methods for heating water using electrical power are known in the art. Electrically powered water heaters advantageously produce hot water without requiring fuel to be supplied for combustion on site. Electrical heating methods include electrical resistance heaters, wherein electrical resistance of heating elements generates heat that is conducted to the working fluid via a conductive heat exchanger such as, for example, a metal vessel. Less commonly, electrical power can be used to produce infrared radiation for heating a fluid. Drawbacks of electrical resistance or infrared heating may include undesirably low energy efficiency and limited rates of hot water output. These drawbacks, in turn, may necessitate large hot water reservoirs as part of system design. Such reservoirs are costly, inefficient and unable to produce a continuous stream of hot water after the reservoir is exhausted.

Other methods of converting electrical energy into heat for heating water or similar fluids are also known. Such methods may include, for example, induction heaters that heat water by inducing electrical currents inside the water, which is then warmed by internal resistance of the water to the induced current. Variations of induction heating may combine induction with electrical capacitance or ionization to transfer thermal energy by interaction with dipolar water molecules. In addition, application of ultrasound to certain liquids is known to cause heating through cavitation, and sonic resonators at less than ultrasonic frequencies have also been developed for heating water. Drawbacks of electrical field or sonic approaches may include the need to modify operation of the heating system based on the electrical or other physical properties of the liquid to be heated. Such properties may vary depending on the water source and quantity of dissolved solids, necessitating water treatment for consistent operation. In addition, in the case of conductive heaters, contact between electrodes and the water or other fluid being heated may cause corrosion.

Notwithstanding the advantages of prior-art methods of electrical water heating, improved methods and equipment would be desirable to overcome these and other limitations of the prior art.

### SUMMARY

Novel methods, system, and apparatus are disclosed herein for heating water or similar substantially incompressible liquids using a specific type of electro-acoustic resonator.

The heater uses a reservoir containing a liquid, for example water, while undergoing heating. The reservoir when filled with water or other liquid to be heated is configured as an energy absorber for an electro-acoustic resonator. The reservoir may be constructed as a cylinder of iron or other suitable material, about 7-10 cm in diameter and 15-18 cm high. A cold water inlet may be provided at a lower end of the reservoir, and angled so as to create a vortex around the perimeter of the reservoir. Likewise, a hot water outlet may be provided at an upper end of the reservoir, and angled so as to continue or reinforce the vortex provided by the water inlet.

An electro-acoustic resonator is mounted inside the reservoir, supported on a shaft fixed to the water reservoir by a system of support arms. The resonator is driven by an alternating current of about 50-60 Hz at about 110 to 230 V. The resonator may include a conductive hemisphere of iron, aluminum or other suitable electrically conductive and acoustically resonant material, which may be about 5-8 cm in diameter. Optionally, the hemisphere may include several holes of 1-8 mm in diameter in its upper portion to facilitate flow of heated liquid from between the hemisphere and the bladder.

The hemisphere component of the electrical-acoustic resonator may be disposed over and closely spaced relative to a sealed spherical bladder about 4-6 cm in outer diameter. The spacing between the bladder and the hemisphere may be in a range of about 1 to 5 mm, for example, 3 mm. The bladder may be constructed of iron or other suitable electrically conductive and acoustically resonant material, for example, aluminum, stainless steel, or brass. The bladder may have a uniform wall thickness in a range of about 1 to 4 mm. The bladder may contain air or similar gas at approximately atmospheric pressure. A ball about 3 cm in diameter, constructed of solid iron or similar hard, dense and durable material may be contained and free to move inside the bladder. The bladder may be electrically connected to ground.

In operation of the heater, electrical power is applied to the electro-acoustic resonator while the reservoir is supplied with the liquid heat-transfer medium (e.g., water or aqueous solution). The alternating current applied to the resonator causes it to resonate inside the reservoir while the reservoir is full of the liquid medium, and causes an electrical current to flow through the liquid between the bladder and the hemisphere. The resonator transfers acoustic and electrical energy to the liquid medium, heating the liquid medium as it passes through the reservoir. The liquid may be used to transfer heat to a heat sink via a heat exchanger, and recirculated through the heater.

A more complete understanding of the method and apparatus for heating a liquid medium by electro-acoustic resonance, and other aspects, will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a schematic diagram illustrating an example of a system and apparatus for heating a liquid medium by electro-acoustic resonance.

FIG. 2 is a block diagram illustrating an example of a system incorporating an electro-acoustic heater.

FIG. 3 is a illustrating an example orientation of a liquid inlet or outlet to a reservoir of an electro-acoustic heater.

FIG. 4 is a simplified perspective view showing certain details of a hemispherical emitter component of an electro-acoustic heater.

FIG. 5 is a flow chart showing an example of a method for heating a liquid medium by electro-acoustic resonance.

FIG. 6 shows a heater with two electro-acoustic resonators arranged in parallel.

FIG. 7 shows a heater with two electro-acoustic resonators arranged in series.

FIG. 8 shows a heater with a piezoelectric electro-acoustic resonator.

### DETAILED DESCRIPTION

The present disclosure describes a solution for heating a liquid medium by electro-acoustic resonance. Inventive aspects of the disclosure may be embodied in an electro-acoustic water heater 100, as shown in FIG. 1. Advantages of the novel heater 100 may include superior thermal efficiency, rapid heating of the medium, absence of moving parts subject to mechanical wear, compact size requiring less than one square meter of area in a wall-mounted form factor, low mass (e.g., less than about 17 kg), and ease of installation as a replacement heater or in new construction. Electrical power requirements for the illustrated example should be about 20 A at 230 V. Although the described example concerns a heater in which the liquid medium comprises water, the inventive concepts may be adapted for heating other liquids. In addition, a liquid heated by the heater may, via a heat exchanger or other heat transfer mechanism, be used for heating gases or solid objects.

As used herein, unless specified otherwise, the words “approximately” or “about” when referring to a numeric quantity include at least similar quantities within a range of plus or minus 10% of the stated value.

An electro-acoustic heater 100 may include a reservoir 102 containing a working liquid 114, for example water or solution of glycol in water, that is heated by absorbing energy from acoustic resonance of an electro-acoustic resonator component 104, and electrical resistance heating. The reservoir 102 may be constructed as a cylinder of iron, galvanized steel, stainless steel, brass, aluminum, structural high-temperature plastic, or other suitable material. For a typical household application, the reservoir 102 may be, for example, about 7-10 cm in diameter and 15-18 cm high. The reservoir 102 may have a uniform wall thickness, for example, in a range of about 1 to 5 mm. Other thicknesses may be appropriate for other materials or geometries. The reservoir 102 may be sized to provide a generally annular minimum space between an outer periphery of an electro-acoustic resonator 104, which may be centrally disposed in the reservoir, in the range of about 0.5 to 2 cm. For example, in the illustrated embodiment, the annular space ‘w’ may be about 1 cm.

A cold liquid medium inlet 118 may be provided at a lower end of the reservoir, and angled so as to create a vortex around the perimeter of the reservoir. Further details about the orientation of the liquid inlet are described below in connection with FIG. 3. Likewise, a hot liquid medium outlet 120 may be provided at an upper end of the reservoir, and angled so as to continue or reinforce the vortex provided by the liquid inlet 118. The orientations of the inlet 118 and outlet 120 may cause a generally helical swirling (vortex) of the liquid medium 114 around the resonator 104 as it passes through the reservoir 102. This swirling acting may enhance operation of the heater 100, for example by increasing turbulent mixing and heat transfer from hot regions of the liquid medium 114 to cooler regions of the medium 114.

The liquid medium 114 may comprise pure demineralized water, or more preferably, may be aqueous solution of glycol in demineralized water. For example, the solution may include 1 to 3 weight percent glycol in pure demineralized water. In the alternative, or in addition, the liquid medium may be an aqueous solution of a selected salt in demineralized water. The type and concentration of salt may be controlled to maintain electric conductivity of the liquid near that of the glycol/water solution.

An electro-acoustic resonator 104 may be mounted inside the reservoir 102, supported on a shaft 132 fixed to the reservoir 102. In the alternative, a system of one or more support arms may be used to mount the resonator 104 inside the resonator 102. In the illustrated example, the shaft 132 also functions as a support arm for both the hemisphere 106 and bladder 108. In some embodiments, the shaft 132 may include a hollow interior, and serve as a conduit for providing electrical power to the resonator 104. In the alternative, power may be provided to the components via insulated wiring (not shown) passing directly through the liquid medium 114. The shaft 132 or other support arm may be electrically insulated from the resonator 112 using one or more insulating bushings (not shown) or other suitable electrically insulating coupling.

The resonator may include a conductive hemisphere 106 constructed of a substantially rigid structural material, for example iron. In the illustrated embodiment, the hemisphere 106 is connected to an alternating current (AC) power source 126, for example, an AC source operating at 50 Hz, 60 Hz, or other frequency in the range of about 110-230 VAC. As the powered component of the resonator 104, the hemisphere 106 is an example of an “emitter” component of a resonator. When installed in a reservoir 102 of a size and proportion as described above, the hemisphere 106 may be about 5-8 cm in outer diameter and may have a uniform wall thickness in a range of about 1 to 4 mm. Optionally, the hemisphere may include several holes 112 of 1-8 mm in diameter, for example three holes about 6 mm in diameter, through its upper portion to facilitate passage of heated liquid. Although the term “hemisphere” is used herein, other sizes and shapes of emitter components may also be functional in an electro-acoustic resonator component 104 provided that the structure is concave and can resonate at a harmonic of the input power frequency, wherein “harmonic” means a resonant frequency that is a non-zero integer multiple of the input AC frequency. For example, a structure that resonates at about 400 Hz with an input power frequency of 50 Hz may be described as resonating at the eighth harmonic, or eight times the input frequency.

The hemisphere component 106 of the electrical-acoustic resonator may be disposed over and closely spaced relative to a sealed bladder 108 about 3-6 cm in outer diameter, for example, 4 cm. In the illustrated embodiment, the bladder 108 is spherical, but other shapes may also be suitable, for example polygonal, ovoid or ellipsoidal. The gap ‘g’ between the bladder and the hemisphere may be in a range of about 1 to 5 mm, for example 3 mm. The gap may have a constant or nearly-constant spacing relative to the surface of the emitter 106 facing the bladder 108. In the illustrated embodiment, the bladder 108 is connected to an electrical ground 128. As the grounded component of the resonator 104, the bladder 108 is an example of a “receiver” component of a resonator. The receiver 108 should be electrically insulated from the emitter 106.

The bladder 108 may be constructed of a substantially rigid structural material, for example iron, and may have a uniform wall thickness in a range of about 1 to 4 mm. The bladder may contain air or similar gas at approximately atmospheric pressure in an interior volume 116. An unrestrained solid mass 110 may be contained and free to move in the interior 116 of the bladder 108, having a mass in the range of about 0.1 to 0.8 that of the bladder 108. The unrestrained solid mass 110 may comprise, for example, a ball about 2 cm in diameter, constructed of solid iron or similar hard, dense and durable material. The ball 110 may occupy about 25% of the interior volume of the bladder 116.

The resonator 104 may be designed and constructed so as to have a primary resonance frequency in the working liquid 114, i.e., a first harmonic frequency, that is equal to or an integer multiple of the operating frequency of the AC power source 126. For example, the hemisphere 106 may have a first harmonic frequency about eight times the frequency of input power. The bladder 108, being a closed sphere, may be much more rigid than the hemisphere 106 and have a correspondingly much higher first harmonic. The system including the ball 110 that is free to move inside the sphere 108 may have a fundamental frequency related to the mass of the ball. The mass of the ball may be selected to provide a targeted fundamental frequency of the bladder-ball system. For example, the mass of the ball 110 may be selected so as to tune the bladder-ball system to a fundamental frequency about fifty times the input power frequency. For example, the bladder-ball system may be tuned to a frequency of about 2.5 to 3 kHz by selecting the mass of the iron ball 110.

In operation of the heater 100, electrical power may be applied to the electro-acoustic resonator 104 while the reservoir is substantially full of the liquid medium 114. The resonator may be driven by an alternating current, for example, about 50 Hz or 60 Hz at about 110 to 230 V. The alternating current applied to the resonator may cause it to resonate at an acoustic frequency, e.g., about 400-480 Hz, inside the reservoir 102 and an electrical current to flow between the emitter 106 and receiver 108. A controller 124 may be used to modulate the AC power source 126 and DC power source 136 in response to temperature feedback from at least one temperature sensor 134, for example a thermocouple, thermistor, or other sensor placed in or near the hot liquid outlet 120. The controller 124 may include a processor coupled to a memory, the memory holding instructions that when executed by the processor, cause the controller to modulate electrical power to the heater 100 in response to temperature feedback. The instructions may define any suitable control algorithm, for example, proportional, proportional-integral, or proportional-integral-derivative control for closed-loop control of an input factor. Meanwhile, the rate at which the liquid medium flows into and out of the respective inlet 118 and outlet 120 may be held constant, or may be varied in response to heat demand by varying the speed of a circulation pump, adjusting a control valve, or some combination thereof.

When powered by the AC power source 126, the resonator transfers acoustic and electrical energy to the liquid medium, heating the liquid as it passes around the resonator 104 on its way from the inlet 118 to the outlet 120. For example, with an electrical power input of about 3.8 kilowatts, an aqueous liquid medium can be heated from 18° C. to 78° C. in a device as described and continuously discharged from the hot outlet at a rate of about one liter per minute. Thus, under the described conditions the heater may achieve a thermal efficiency as high as approximately 96%. Further details are provided in examples later in the specification.

An example of a system 200 incorporating an electro-acoustic heater 202 is shown in FIG. 2. The heater 202 may be of the same type as heater 100 shown in FIG. 1. A controller 204 controls an outlet temperature of the liquid medium, as previously described. The liquid medium may be passed through at least one heat exchanger 208, which may be configured as a space heater (e.g., radiator or baseboard heater), liquid heater (e.g., water heater, process heater), or structural heater (e.g., floor heater or deicer.) Once cooled by heat exchange in the exchanger 208, the liquid medium may be recirculated back to the heater 202 by a recirculation pump 206. The pump 206 may be controlled by the controller 204, or may be controlled by a separate controller (not shown) independently of controller 204. Use of a recirculating heat transfer fluid may enable more reliable operation of the heater 202 due to greater control and stability of the properties of the liquid medium.

FIG. 3 illustrates an orientation of a liquid inlet or outlet 302 to a reservoir 300 of an electro-acoustic water heater (e.g., heater 100), for causing or facilitating a vortex of the liquid medium around a periphery of the reservoir. The reservoir 300 may be generally cylindrical and have a circular outer periphery. A central axis 304 of the outlet 302 is located at a point along a circle 312 offset inward from the circular outer periphery of the heater, where a line perpendicular to tangent line 308 crosses the circle 312. The central axis 304 of the outlet is parallel to an imaginary line 306. The line 306 lies in a plane 310 that is parallel to the vertical axis 314 of the reservoir 300. The line 306 is inclined at an angle ‘α’ to the tangent line 308, wherein ‘α’ is in the range of about 10° to 80°, for example, at 45°. Accordingly, a liquid inlet may be disposed at a lower end of the cylinder 300 having an inlet channel oriented at an acute angle in the range of about 10° to 80° to the tangent to the cylinder immediately adjacent to the inlet and in a plane substantially parallel to the central axis 314 of the reservoir. Likewise, a liquid outlet may be disposed at an upper end of the cylinder having an outlet channel oriented at an acute angle in the range of about 10° to 80° to the tangent to the cylinder immediately adjacent to the outlet and in a plane substantially parallel to the central axis 314 of the reservoir.

FIG. 4 is a simplified perspective view showing certain details of a hemispherical emitter component 400 of an electro-acoustic water heater (e.g., heater 100), such as its generally hemispherical shape and a set of holes 402 (e.g., three holes) arranged near the upper mounting hole 406 opposite a lower periphery 404 of the component 400. For a heater according to the example of FIG. 1, the holes may be on the order of about 6 to 8 mm in diameter. One or more additional rows of holes (not shown) may be provided in addition to the first set of holes 402, if desired, or a greater number of smaller holes may be used. The upper mounting hole may be fixed to and filled by a support arm during use. The provided holes 402 may improve liquid flow through the narrow space between the emitter 400 and a complementary bladder/receiver of a resonator. Liquid heated in the gap between the hemispherical component 400 and the closely-spaced bladder (FIG. 1) may more easily escape via the holes 402, being driven upward by convection and/or boiling. The escaping heated liquid may be replaced by cooler liquid entering the gap near the lower perimeter 404.

FIG. 5 shows an example of a method 500 for heating a liquid by electro-acoustic resonance. The method 500 may include, at 502, contacting a liquid to be heated with an electro-acoustic resonator characterized by having a first harmonic frequency. For example, a substantially rigid reservoir containing a resonator as described herein may be filled with a liquid to be heated. The first harmonic frequency may be, for example, about 400 Hz for an input AC power frequency of about 50 Hz, or about 480 Hz for an input AC power frequency of about 60 Hz. In a more detailed aspect of the method, the electro-acoustic resonator may be supported during performance of the method by attachment to at least one wall of the reservoir, for example via a support arm as previously described.

The liquid may be, or may include water. For example, the liquid may be an aqueous solution of glycol, in the range of about one to three weight percent in demineralized water. The aqueous solution may be circulated as a heat transfer fluid through the reservoir and a separate heat exchanger supplying heat to the target heat sink.

The method 500 may further include, at 504, supplying AC power to the electro-acoustic resonator having a frequency of approximately one-eighth the first harmonic frequency until the liquid is heated. Other ratios of power frequency to the first harmonic of the resonator may be useful, depending on the characteristics of the liquid to be heated. It should be appreciated that the first resonant frequency of the resonator, in the range of about 400 to 480 Hz for the example described herein, may be much lower than the range of frequencies considered ultrasonic, which begins at around 20 kHz or higher. The AC power frequency may be, for example, in a range of about 49 to 61 Hz. Application of AC power may cause an electric current to flow between components of the resonator, for example a current may pass between the hemisphere 106 and bladder 108 during operation. In one example discussed in more detail below, about 3.8 kW of AC power was supplied to a resonator as shown in FIG. 1, causing a current of about 18 A to flow. Heating of the liquid in the gap may occur both because of electrical resistance of the liquid in the gap and because of sonic heating or some other phenomenon.

In an aspect of the method, the electro-acoustic resonator may include a hemispherical component disposed over a bladder, as described in more detail herein. In such embodiments, supplying the AC power may include connecting the hemispherical component to the AC power source, and the bladder to ground. The bladder may be filled with air, nitrogen, or similar gas at approximately atmospheric pressure, and may contain an unrestrained mass, for example an iron ball about 2 cm in diameter. Such a ball may have a mass of about 33 g, and may have a frequency of vibration inside the bladder about fifty times greater than the frequency of the input AC power, for example, about 2.5 to 3 kHz, still below ultrasonic. The method 500 may include other, more detailed aspects as described elsewhere herein.

The electro-acoustic heater as described herein may not scale effectively to dimensions substantially smaller or larger than the ranges disclosed herein. Consequently, to achieve a rate of heat output larger than about 4 kW, it may be desirable to combine multiple electrical-acoustic resonators in a single unit. For example, as shown in FIG. 6, a parallel multi-resonator heater 600 may include a first resonator 602 and a second resonator 604 in a parallel arrangement sharing a common reservoir 600. The reservoir 606 may be divided by a barrier 608 of stainless steel or other suitable material, creating parallel cells 610, 612 in which the respective resonators 602, 604 are placed. The liquid medium may flow through the cells 610, 612 in parallel, entering via respective inlets 614, 616 and exiting via respective outlets 618, 620. In other aspects each of the cells 610, 612 may be operated and used similarly to a single cell resonator as described herein above. The resonators 602, 604 may be controlled separately or in tandem using a controller and control method as described herein for a single-resonator heater. Any plural number of resonators may similarly be configured in parallel.

In an alternative, it may also be able to increase the rate of heat output by arranging single resonator units in series. For example, as shown in FIG. 7, a serial multi-resonator heater 700 may include a first resonator 702 and a second resonator 704 sharing a common reservoir 706, which may comprise, for example, a stainless steel tube. Characteristically of a serial arrangement, the working liquid is first heated by the first resonator 702 and then additionally heated by the next resonator 704 in the series. The working liquid may be supplied to the reservoir 706 via a common inlet 708 and exit via a common outlet 710. In other aspects the serial heater 700 may be operated and used similarly to a single cell resonator as described herein above. The resonators 702, 704 may be controlled separately or in tandem using a controller and control method as described herein for a single-resonator heater. Any plural number of resonators may similarly be configured in series.

Because of the high efficiency that may be achieved using a heater as disclosed herein, it may be desirable to supply electrical power to the heater using a solar panel or the like. This may be advantageous for remote installation, or to avoid drawing power from a utility grid for economic or environmental reasons. For example, for domestic use a heater of the type disclosed may be capable of a rate of heat output of almost 4 kW at an efficiency of about 96%. To support this heater, a 5 kW solar power system may be all that is necessary, or may be even more than is necessary. As manufacturing capacity increases, the cost of such systems have become increasingly affordable, currently standing at about $2 per Watt and placing them within reach of an increasing number of households. Such a system, comprising a heater as disclosed herein coupled to one or more heat exchangers for water and space heating and supplied by a solar system, may be capable of providing sufficient hot water and space heating for many domestic installations without consuming any fossil fuels. However, any desirable source of electric power may be used to supply the systems described herein.

In some applications, it may be desirable to power an electro-acoustic heater using direct current (DC) power, for example when using a solar panel. Although it is possible to convert DC to AC power using an inverter, doing so entails additional expense. However, without an inverter, DC power may not be useful for driving acoustic resonance of an electro-acoustic resonator. In such case, it may be desirable to drive acoustic resonance by some other method, for example a magnetic coil or piezoelectric transducer. FIG. 8 shows an example of a heater 800 using one or more piezoelectric transducers 808, 810 to drive an electro-acoustic resonator 802. In the illustrated example, the emitter 804 and the receiver 806 comprise porous acoustic resonators, for example metal plates including an array of through holes, or rigid metal meshes or grids. One or more first piezo electric transducers 808 may be acoustically coupled to the emitter 804, and configured to drive the emitter at a first acoustic frequency, for example a frequency in the range of about 400 to 500 Hz. One or more second piezo electric transducers 810 may be acoustically coupled to the emitter 806, and configured to drive the emitter at a second acoustic frequency, for example a frequency in the range of about 2.5 kHz to 3 kHz.

In an alternative, the first transducers 808 and/or second transducers 810 may transfer most or all of their acoustic energy output to the liquid medium in the container 814, and the emitter 804 and/or receiver 806 may function as essentially non-vibrating electrodes. If so, the transducers 808, 810 may be mounted elsewhere, for example on an interior wall or walls of the container 814, instead of on the emitter 804 or receiver 806.

The cold liquid medium may be supplied to the container 814 at a lower inlet 818, and exit at an upper outlet 816 after passing through and being heated by the electro-acoustic resonator 802. The resonator 802 may be supported by one or more support arm 812 in a manner similar to other embodiments described herein. Electrical power may be supplied by a power source 822, example a solar panel, which may supply AC or DC power to the emitter 804 while the receiver 806 is connected to electrical ground. The supplied power and transducers 808, 810 may be controlled by a controller component 820. Other aspects of the heater 800 may be similar to other embodiments described herein.

The previous description of the electro-acoustic heater and method of using the heater is provided to enable any person skilled in the art to make or use the apparatus, systems and methods described. Various modifications to the described apparatus, systems and methods may be apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A method for heating a liquid, comprising:
contacting a liquid to be heated with an electro-acoustic resonator characterized by having a first harmonic frequency; and
supplying an alternating current (AC) power having a frequency of approximately one-eighth the first harmonic frequency to the electro-acoustic resonator until the liquid is heated.

2. The method of claim 1, further comprising containing the liquid in a reservoir, while supplying the electro-acoustic resonator with the AC power.

3. The method of claim 2, wherein the reservoir is substantially rigid.

4. The method of claim 3, wherein the electro-acoustic resonator is supported during performance of the method by attachment to at least one wall of the reservoir.

5. The method of claim 1, wherein the liquid comprises a solution of glycol in water.

6. The method of claim 5, wherein the glycol is in the range of 1% to 3% of the solution, by weight.

7. The method of claim 1, wherein the electro-acoustic resonator comprises a hemispherical component disposed over and connected to a bladder, and an unrestrained solid mass contained inside the bladder.

8. The method of claim 7, wherein supplying the AC power causes the resonator to vibrate at the first harmonic, and the unrestrained solid mass to vibrate inside the bladder at a fundamental frequency approximately fifty times the frequency of the AC power.

9. The method of claim 8, wherein supplying the AC power comprises connecting the hemispherical component to the AC power and the bladder to electrical ground.

10. The method of claim 1, wherein the AC power is supplied at a frequency in the range of about 49 to 61 Hz.

11. The method of claim 1, further comprising withdrawing the liquid in a heated state from the reservoir, cooling the liquid in a heat exchanger, and recirculating the liquid downstream of the heat exchanger to the reservoir.

12. An electro-acoustic resonator, comprising:
a concave rigid emitter;
a substantially hollow receiver mounted at least partially within the concave rigid emitter and spaced apart therefrom; and
an unrestrained solid mass contained inside the substantially hollow receiver.

13. The electro-acoustic resonator of claim 12, wherein the concave rigid emitter comprises a hemisphere having a diameter in a range of about 7 to 10 cm.

14. The electro-acoustic resonator of claim 13, wherein the hemisphere is pierced by holes, each of the holes having a diameter in a range of about 6 to 8 mm.

15. The electro-acoustic resonator of claim 12, wherein the substantially hollow receiver comprises a substantially spherical bladder having a diameter in a range of about 5 to 6 cm.

16. The electro-acoustic resonator of claim 12, wherein the unrestrained solid mass comprises a ball having a diameter in a range of about 2 to 4 cm.

17. The electro-acoustic resonator of claim 12, wherein the resonator has a first harmonic approximately eight times a frequency of an input AC power.

18. The electro-acoustic resonator of claim 17, wherein the unrestrained solid mass in configured to have a fundamental frequency of vibration inside the bladder approximately six times the first harmonic.

19. A apparatus for heating a liquid, comprising:
a container; and
an electro-acoustic resonator disposed at least partially inside the container, the resonator comprising a hemispherical component disposed over a bladder, and an unrestrained solid mass contained inside the bladder.

20. The apparatus of claim 19, further comprising at least one support arm mounting the electro-acoustic resonator to the container.

21. The apparatus of claim 19, wherein the container comprises a substantially cylindrical reservoir, the cylinder having a diameter in a range of about 9 to 12 cm and a length in a range of about 15 to 18 cm.

22. The apparatus of claim 21, wherein the electro-acoustic resonator has a largest diameter in a range of about 7 to 10 cm, which largest diameter is about 2 cm less than the diameter of the cylinder.

23. The apparatus of claim 19, further comprising a liquid inlet disposed at a lower end of the cylinder having an inlet channel oriented at an acute angle in the range of about 10° to 80° to a tangent to the cylinder immediately adjacent to the inlet and in a plane parallel to a central axis of the reservoir.

24. The apparatus of claim 21, further comprising a liquid outlet disposed at an upper end of the cylinder having an outlet channel oriented at an acute angle in the range of about 10° to 80° to a tangent to the cylinder immediately adjacent to the outlet and in a plane parallel to a central axis of the reservoir.
